(19) United States
(12) Patent Application Publication
(10) Pub. No.: US 2019/0014546 A1
(43) Pub. Date: Jan. 10, 2019

(54) METHOD AND APPARATUS FOR INDICATING POWER ALLOCATION IN MULTIUSER SUPERPOSITION TRANSMISSION

(71) Applicant: ALCATEL LUCENT, Boulogne-Billancourt (FR)

(72) Inventors: Zhuo Wu, Shanghai (CN); Jun Wang, Shanghai (CN); Gang Shen, Shanghai (CN); Min Zhang, Shanghai (CN)

(73) Assignee: Alcatel Lucent, Nozay (FR)

(21) Appl. No.: 15/750,561

(22) PCT Filed: Jul. 22, 2016
(86) PCT No.: PCT/IB2016/001137

§ 371 Date: Feb. 6, 2018

(30) Foreign Application Priority Data
Aug. 6, 2015 (CN) 201510478372.X

(51) Int. Cl. H04W 52/54; H04W 52/16; H04W 52/34; H04W 52/24; H04L 25/03

(52) U.S. Cl. CPC H04W 52/54; H04W 52/16; H04L 25/03006; H04W 52/243; H04W 52/346

(57) ABSTRACT

Embodiments of the present disclosure provide a method and apparatus for indicating power allocation in multiuser superposition transmission. The method comprises: transmitting a signaling for indicating a first power parameter and a first power offset to a first UE so that the first UE determines first power allocation information specific to it based on the first power parameter and the first power offset; and transmitting a signaling for indicating a second power parameter and a second power offset to a second UE paired with the first UE so that the second UE determines second power allocation information specific to it based on the second power parameter and the second power offset. Embodiments of the present disclosure enable the near/victim UE of paired UEs to decode an interference signal caused by far/interfering UE based on power allocation information and remove the interference signal caused by far/interfering UE to improve correctness of decoding its own physical downlink shared channel data.

### FIELD

Embodiments of the present disclosure on the whole relate to power allocation indication, and more particularly relate to a method and apparatus for indicating power allocation in multiuser superposition transmission.

### BACKGROUND

In downlink multiuser superposition transmission (hereinafter referred to as MUST), multiple user equipment (UEs) are paired to enable their simultaneous transmission of more than one layer of data without separation of time, frequency and spatial layer (i.e. using the same spatial precoding vector or the same transmission diversity scheme over the same resource elements).

For example, FIG. 1 illustrates such a scenario. In FIG. 1, UE1 will suffer from interference from UE2 seriously because UE2 is at the cell edge and is allocated with a large transmission power. UE1 with advanced receiver is expected to first decode UE2's signal and then remove it from the received signals, and then decode UE1's own physical downlink shared channel (PDSCH) data. Thus, whether the interference signal caused by UE2 can be cancelled and how much interference could be cancelled is critical for UE1 to decode its own data. To decode UE2's signal at UE1, the information of the allocated transmission power between the paired two UEs (i.e. UE1 and UE2) is crucial to the receiver at UE1. Without power allocation information, it will be rather difficult to correctly decode the interference signal at the near/victim UE (i.e. UE1) and it also impacts the decoding correctness of UE1's own PDSCH data after removing the interference from the far/interfering UE (i.e. UE2).

However, the indication of the power allocation from an enhanced nodeB (eNB) to UEs in MUST is not specified by current standards.

### SUMMARY

Embodiments of the present disclosure intend to provide a method and apparatus for indicating power allocation in multiuser superposition transmission.

According to a first aspect of the present disclosure, a method for indicating power allocation in multiuser superposition transmission is provided, comprising: transmitting a signaling for indicating a first power parameter and a first power offset to a first UE so that the first UE determines first power allocation information specific to it based on the first power parameter and the first power offset; and transmitting a signaling for indicating a second power parameter and a second power offset to a second UE paired so that the second UE determines second power allocation information specific to it based on the second power parameter and the second power offset.

In some embodiments, the first UE and the second UE are located in the same cell.

In some embodiments, transmitting a signaling for indicating the first power parameter and the first power offset to the first UE further comprises: transmitting a signaling for indicating the second power parameter and the second power offset to the first UE.

In some embodiments, the method further comprises: transmitting a signaling for indicating Gray mapping operation to the first UE for multiuser superposition transmission based on Gray mapping.

According to a second aspect of the present disclosure, a method for indicating power allocation in multiuser superposition transmission is provided, comprising: receiving a signaling for indicating a power parameter and a power offset; and determining power allocation information specific to a UE based on the power parameter and the power offset.

In some embodiments, if the UE is a first UE, receiving the signaling indicating the power parameter and the power offset comprises: receiving a signaling for indicating a first power parameter and a first power offset; and receiving a signaling for indicating a second power parameter and a second power offset associated with a second UE; wherein the first UE and the second UE are located in the same cell.

In some embodiments, if the UE is the first UE, determining power allocation information specific to the UE based on the power parameter and the power offset comprises: determining first power allocation information specific to the first UE based on the first power parameter and the first power offset; and determining second power allocation information specific to the second UE based on the second power parameter and the second power offset.

In some embodiments, if the UE is the first UE, the method further comprises: decoding a signal of the second UE based on the second power allocation information; and removing interference caused by the second UE based on the decoded signal of the second UE.

In some embodiments, if the UE is the first UE, the method further comprises: receiving a signaling for indicating Gray mapping operation; and decoding the received signal based on the signaling for indicating Gray mapping operation.

In some embodiments, if the UE is the second UE, receiving the signaling for indicating the power parameter and the power offset comprises: receiving a second signaling for indicating the second power parameter and the second power offset; and determining second power allocation information specific to the UE based on the power parameter and the power offset comprises: determining power allocation information specific to the second UE based on the second power parameter and the second power offset.

According to a third aspect of the present disclosure, an apparatus for indicating power allocation in multiuser superposition transmission is provided, comprising: first transmitting unit configured to transmit a signaling for indicating a first power parameter and a first power offset to a first UE so that the first UE determines first power allocation information specific to it based on the first power parameter and the first power offset; and second transmitting unit configured to transmit a signaling for indicating a second power parameter and a second power offset to a second UE paired so that the second UE determines second power allocation information specific to it based on the second power parameter and the second power offset.

In some embodiments, the first UE and the second UE are located in the same cell.

In some embodiments, the first transmitting unit is further configured to transmit a signaling for indicating the second power parameter and the second power offset to the first UE.

In some embodiments, the apparatus further comprises: third transmitting unit configured to transmit a signaling for indicating Gray mapping operation to the first UE for multiuser superposition transmission based on Gray mapping.

According to a fourth aspect of the present disclosure, an apparatus for indicating power allocation in multiuser superposition transmission is provided, comprising: first receiving unit configured to receive a signaling for indicating a power parameter and a power offset; and determining unit configured to determine power allocation information specific to a UE based on the power parameter and the power offset.

In some embodiments, if the UE is a first UE, the first receiving unit is configured to: receive a signaling for indicating a first power parameter and a first power offset; and receive a signaling for indicating a second power parameter and a second power offset associated with a second UE; wherein the first UE and the second UE are located in the same cell.

In some embodiments, if the UE is the first UE, the determining unit is configured to: determine first power allocation information specific to the first UE based on the first power parameter and the first power offset; and determine second power allocation information specific to the second UE based on the second power parameter and the second power offset.

In some embodiments, if the UE is the first UE, the apparatus further comprises: first decoding unit configured to decode a signal of the second UE based on the second power allocation information; and interference removing unit configured to remove interference caused by the second UE based on the decoded signal of the second UE.

In some embodiments, if the UE is the first UE, the apparatus further comprises: second receiving unit configured to receive a signaling for indicating Gray mapping operation; and second decoding unit configured to decode a received signal based on the signaling for indicating Gray mapping operation.

In some embodiments, if the UE is the second UE, the first receiving unit is configured to: receive a second signaling for indicating a second power parameter and a second power offset; and the determining unit is configured to: determine power allocation information specific to the second UE based on the second power parameter and the second power offset.

The method and apparatus for indicating power allocation in multiuser superposition transmission according to the embodiments of the present disclosure enable the near/victim UE of paired UEs to decode an interference signal caused by far/interfering UE based on power allocation information and remove the interference signal caused by far/interfering UE to improve correctness of decoding its own PDSCH data.

### BRIEF DESCRIPTION OF THE ACCOMPANYING DRAWINGS

The drawings are provided herein to facilitate further understanding of the present disclosure and form a part of the present disclosure. Exemplary embodiments of the present disclosure and their description are employed to illustrate the present disclosure and do not constitute improper limit of the present disclosure. In the drawings:

FIG. 1 illustrates a schematic diagram of a scenario 100 that can implement the embodiments of the present disclosure;

FIG. 2 illustrates a flow diagram of a method 200 for indicating power allocation in multiuse superposition transmission according to the embodiments of the present disclosure;

FIG. 3 illustrates a flow diagram of a method 300 for indicating power allocation in multiuse superposition transmission according to the embodiments of the present disclosure;

FIG. 4 illustrates a flow diagram of an apparatus 400 for indicating power allocation in multiuse superposition transmission according to the embodiments of the present disclosure;

FIG. 5 illustrates a block diagram of an apparatus 500 for indicating power allocation in multiuse superposition transmission according to the embodiments of the present disclosure;

In the drawings, the identical or corresponding reference sign represents the identical or corresponding part.

### DETAILED DESCRIPTION OF EXAMPLE EMBODIMENTS

Hereinafter, exemplary embodiments of the present disclosure will be described in detail with reference to the drawings. It should be noted that the drawings and the description thereof only relate to the exemplary embodiments. It should be pointed out that the alternative embodiments of the structure and method of the present disclosure would be readily contemplated according to the following description and be employed without departing from the principles for which protection is sought for in the present disclosure.

It should be appreciated that the exemplary embodiments are given only to facilitate those skilled in the art in better understanding and further implementing the present disclosure, rather than to limit the scope of the present disclosure in any manner.

Terms like “comprising” and “including” and others used herein should be interpreted as inclusive terms, namely, “comprising/including but not limited to”; The term “based on” denotes “at least partially based on”; the term “an embodiment” denotes “at least one embodiment”; the term “another embodiment” represents “at least one another embodiment”. The definition of other terms will be given in the following text.

Hereinafter, the technical solution for indicating power allocation in multiuser superposition transmission according to the embodiments of the present disclosure will be described in detail with reference to the drawings.

Currently there are ten different transmission modes (TMs) defined for LTE. They differ in terms of the specific structure of the antenna mapping and also in terms of what reference signals are accustomed to be used for demodulation (cell-specific reference signals (CRS) or demodulation reference signals (DM-RS) respectively) and how CSI is acquired by the terminal and fed back to the network. In case of transmission modes 1 to 6, CRS are to be used for channel estimation, also referred to as CRS-based TMs. Since for different transmission modes, the schemes for power allocation indication and related modulation and demodulation process will be quite different. With CRS-based TMs, TM2 normally refers to non-codebook-based transmission diversity scheme, which assumes the use of CRS for channel estimation. For the purpose of description, the present disclosure will focus on TM2 while it should be appreciated that the scope of the present disclosure is not limited to this aspect.

There are four parameters about power allocation defined in the current standards: ρ_{A}, ρ_{B}, P_{A} and P_{B}. To detect or decode CRS, normally the transmission power of reference signals is set higher than other signals or channels. Therefore, a cell-specific parameter P_{B} is used to boost the power of reference signals and obtain better channel estimation performance. The ratio of PDSCH energy per resource element (EPRE) to CRS EPRE for each OFDM symbol is denoted by ρ_{A} or ρ_{B} according to the OFDM symbol index. ρ_{A} and ρ_{B} are cell-specific parameters while P_{A} is a UE specific parameter. The value of P_{A} impacts the decoding performance of UE's PDSCH data and interferences caused by neighboring cells. Currently in 3GPP standards, P_{A} is selected from the values of the set {−6, −4.77, −3, −1.77, 0, 1, 2, 3} dB.

In MUST, paired UEs will use the same transmission diversity scheme over the same resource element (RE). Since the far/interfering UE is normally allocated with much higher transmission power than the near/victim UE, the definition of current P_{A} values of UEs set by current 3GPP standards may not satisfy the case of MUST. Therefore, besides the current P_{A} indication, for MUST, there should be a new power indication parameter P_{A}′ to indicate the transmission power on PDSCH for both near UE and far UE. Moreover, near/victim UE also needs to obtain power allocation information of far/interfering UE apart from its own power allocation information, thus can decodes and removes interference signal caused by far/interfering UE and then decodes its own PDSCH data.

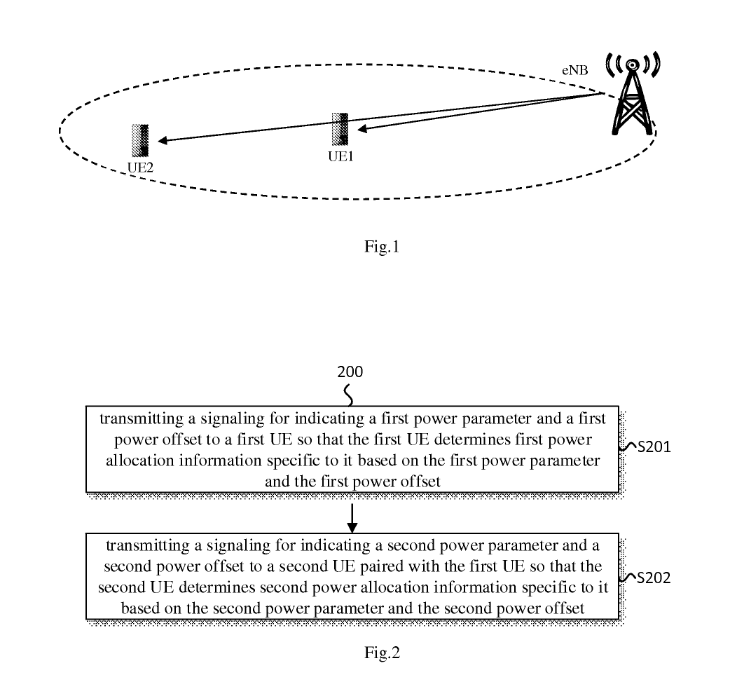

FIG. 2 illustrates a flow diagram of a method 200 for indicating power allocation in multiuser superposition transmission according to the embodiments of the present disclosure. As shown in FIG. 2, the method 200 comprises steps S201 and S202. Steps of the method 200 will be described in detail now with reference to FIGS. 1 and 2. According to the embodiments of the present disclosure, the method 200 may be, for instance, implemented by the eNB in FIG. 1.

At the step S201, transmitting a signaling for indicating first power parameter and first power offset to UE1 so that UE1 determines first power allocation information specific to it based on a first power parameter and a first power offset. The first power parameter can be UE1 specific P_{A} parameter, for example, can be marked as P_{A}_{_}₁. As defined in the current 3GPP standards, the value of P_{A}_{_}₁ can be selected from the following set: {−6, −4.77, −3, −1.77, 0, 1, 2, 3} dB. The first power offset may be represented with P_{A}_{_}ₘᵤₛₜ_{_}_{offset}_{_}₁ The signaling for indicating P_{A}_{_}₁ and P_{A}_{_}ₘᵤₛₜ_{_}_{offset}_{_}₁ may be transmitted to UE1 by the eNB so that UE1 determines first power allocation information specific to UE1 based on P_{A}_{_}₁ and P_{A}_{_}ₘᵤₛₜ_{_}_{offset}_{_}₁ and marks it as P_{A}_{_}₁′, for example, P_{A}_{_}₁′=P_{A}_{_}₁+P_{A}_{_}ₘᵤₛₜ_{_}_{offset}_{_}₁.

Next, the method 200 moves to the step S202, transmitting a signaling for indicating a second power parameter and a second power offset to UE2 so that UE2 determines second power allocation information specific to it based on second power parameter and second power offset. The second power parameter can be UE2 specific P_{A} parameter, for example, can be marked as P_{A}_{_}₂. As defined in the current 3GPP standards, the value of P_{A}_{_}₂ can be selected from the following set: {−6, −4.77, −3, −1.77, 0, 1, 2, 3} dB. The second power offset may be represented with P_{A}_{_}ₘᵤₛₜ_{_}_{offset}_{_}₂. The signaling for indicating P_{A}_{_}₂ and P_{A}_{_}ₘᵤₛₜ_{_}_{offset}_{_}₂ may be transmitted by the eNB to UE2 so that UE2 determines second power allocation information specific to UE2 based on P_{A}_{_}₂ and P_{A}_{_}ₘᵤₛₜ_{_}_{offset}_{_}₂ and marks it as P_{A}_{_}₂′, for example, P_{A}_{_}₂′=P_{A}_{_}₂+P_{A}_{_}ₘᵤₛₜ_{_}_{offset}_{_}₂.

According to the embodiments of the present disclosure, as shown in FIG. 1, UE 1 and UE2 are located in the same cell, wherein UE1 is located in the relatively more central position while UE2 is located in the edge of the cell. As stated above, UE1 will suffer from interference from UE2 seriously because UE2 is allocated with a significant larger transmission power than UE1. Thus, UE1 is expected to first decode UE2's signal and then remove the UE2's signal from the received signals to improve correctness of decoding its own signal.

According to the embodiments of the present disclosure, the step S201 further comprises transmitting a signaling for indicating a second power parameter P_{A}_{_}₂ and second power offset P_{A}_{_}ₘᵤₛₜ_{_}_{offset}_{_}₂ to UE1. In other words, power parameter and power offset associated with UE2 at cell edge can be transmitted simultaneously to UE1 by eNB so that UE1 can decode UE2's signal based on the information and remove the UE2's signal from the received signals to improve correctness of decoding its own signal.

According to the embodiments of the present disclosure, P_{A}_{_}ₘᵤₛₜ_{_}_{offset}_{_}₁ and P_{A}_{_}ₘᵤₛₜ_{_}_{offset}_{_}₂ transmitted to UE1 may be specific values. According to other embodiments of the present disclosure, power allocation ratio between UE1 and UE2 can be transmitted to UE1, for example, power allocated between UE1 and UE2 is 90% and 10%, 80% and 20%, or 70% and 30%. Based on the ratio, UE1 will can compute the associated P_{A}_{_}ₘᵤₛₜ_{_}_{offset} (including P_{A}_{_}ₘᵤₛₜ_{_}_{offset}_{_}₁ and P_{A}_{_}ₘᵤₛₜ_{_}_{offset}_{_}₂)

Besides, for MUST, a plurality of UEs's signals may be combined in the manner of linear combination and Gray mapping. For Gray-mapping-based MUST combination, the near UE should first decode the combined signals with the superposed constellation map and then derive decoded signals for the near UE therefrom. Meanwhile, Gray mapping may be realized by operations such as flipping, XOR or XNOR on the UEs's signals. Thus, near UE should learn specific operation for Gray mapping to derive the correct information out of the decoded superposed signals after decoding the superposed signals.

According to the embodiments of the present disclosure, for multiuser superposition transmission based on Gray mapping, the method 200 further comprises transmitting a signaling including Gay mapping indications (marked as GMMI) to UE1. For example, the signaling for indicating Gray mapping operation could be designed in two ways:
GMMI is optional. That is, for multiuser superposition transmission without Gray mapping, there is no need to send GMMI to UE1; for multiuser superposition transmission with varied mappings, sending GMMI to UE1 to indicate index of Gray mapping operation (e.g. flipping, XOR or XNOR).
GMMI is mandatory. That is, sending GMMI=0 to indicate multiuser superposition transmission without Gray mapping; sending GMMI #0 to indicate the index of gray mapping operation (e.g. flipping, XOR or XNOR).

Until now, the method 200 ends.

FIG. 3 illustrates a flow diagram of a method 300 indicating power allocation in multiuser superposition transmission according to the embodiments of the present disclosure. As shown in FIG. 3, the method 300 comprises steps S301 and S302. Steps of the method 300 will be described in detail now with reference to FIGS. 1 and 3.

According to the embodiments of the present disclosure, the method 300 may be, for example, implemented with UE1 or UE2 in FIG. 1. First of all, the case of the method 300 implemented with UE1 in FIG. 1 will be described.

At the step S301, receiving a signaling for indicating power parameter and power offset. Take the scenario 100 shown in FIG. 1 as an example. UE1 may receive a signaling for indicating a first power parameter and a first power offset from the eNB. The first power parameter may be UE1 specific P_{A} parameter, for example, can be marked as P_{A}_{_}₁. As defined in the current 3GPP standards, the value of P_{A}_{_}₁ can be selected from the following set: {−6, −4.77, −3, −1.77, 0, 1, 2, 3} dB. The first power offset may be represented with P_{A}_{_}ₘᵤₛₜ_{_}_{offset}_{_}₁.

According to the embodiments of the present disclosure, in the scenario 100 shown in FIG. 1, UE1 will suffer from interference from UE2 seriously because UE2 is allocated with a significant larger transmission power than UE1. Thus, UE1 is expected to first decode UE2's signal and then remove the UE2's signal from the received signals to improve correctness of decoding its own signal. Therefore, UE 1 may also receive a signaling for indicating second power parameter and a second power offset associated with UE2. The second power parameter can be UE2 specific P_{A} parameter, for example, can be marked as P_{A}_{_}₂. As defined in the current 3GPP standards, the value of P_{A}_{_}₂ can be selected from the following set: {−6, −4.77, −3, −1.77, 0, 1, 2, 3} dB. The second power offset may be represented with P_{A}_{_}ₘᵤₛₜ_{_}_{offset}_{_}₂.

Next, the method 300 moves to the step S302, determining power allocation information specific to UE based on power parameter and power offset. According to the embodiments of the present disclosure, for example, first power allocation information P_{A}_{_}₁′ specific to UE1 may be determined by calculating P_{A}_{_}₁+P_{A}_{_}ₘᵤₛₜ_{_}_{offset}_{_}₁ Moreover, to decode UE2's signal, UE1 further receives a second power parameter P_{A}_{_}₂ and a second power offset P_{A}_{_}ₘᵤₛₜ_{_}_{offset}_{_}₂ associated with UE2. Thus, second power allocation information P_{A}_{_}₂′ specific to UE2 may be determined based on P_{A}_{_}₂ and P_{A}_{_}ₘᵤₛₜ_{_}_{offset}_{_}₂, for example, P_{A}_{_}₂′=P_{A}_{_}_{—2}+P_{A}_{_}ₘᵤₛₜ_{_}_{offset}_{_}₂.

According to the embodiments of the present disclosure, method 300 further comprises decoding UE2's signal based on the second power allocation information P_{A}_{_}₂′. As the power allocation information P_{A}_{_}₂′ specific to UE2 has been determined and the rest power allocation parameters, for example, ρ_{B}/ρ_{A}, are cell-specific, channel estimation may be implemented based on the information and UE2's signal may be decoded. After the UE2's signal has been decoded, interference caused by UE2 may be removed from the signal received from UE1 based on the decoded UE2's signal. Then, UE1 may decode its own PDSCH signal based on the first power allocation information P_{A}_{_}₁′.

According to the embodiments of the present disclosure, signals of UE1 and UE2 can be combined with Gray mapping. Under this condition, UE1 should learn the specific operation for Gray mapping to derive the correct information out of the decoded superposed signals after decoding the superposed signals. According to such embodiments, UE1 may receive a signaling for indicating Gray mapping operation from eNB, namely, a signaling comprising GMMI. As stated above, GMMI may be index indicating Gray mapping operation (e.g. flipping, XOR or XNOR). Then after decoding the superposed signals, UE1 may implement inverse operation of Gray mapping operation indicated by the index for the decoded superposed signals and thus obtain its own decoded signal.

For the multiuser superposition transmission based on Gray mapping, when the superposed constellation maps are uniform constellation maps, the ratio of transmission power allocated to UE1 and UE2 is indicated to be fixed. In this case, there are only 6 limited combinations of modulated signals of UE1 and UE2. Thus, a table of correspondences between modulation schemes and ratios of power allocation of UE1 and UE2 can be set up. Based on the obtained power allocation information of UE1 and UE2, UE1 may obtain the power allocation ratio between them and thus, further determine if the ratio corresponds to one of the six combinations. In this manner, UE1 may first decode the combined signals with uniform constellation maps and then derive its own signals from the decoded combined signals based on the determined manner of combination. When the superposed constellation map is non-uniform, it is indicated that the ratio of transmission power between UE1 and UE2 is variable. In this case, before decoding the combined signals, UE1 should firstly obtain the power allocation information of UE1 and UE2 and compute the variation of superposed constellation map with the modulation and coding strategy (MCS) information of the paired UE1 and UE2.

As stated above, the method 300 may also be implemented with UE2 shown in FIG. 1. Under this condition, at the step S301, UE2 may receive a signaling for indicating a second power parameter P_{A}_{_}₂ and a second power offset P_{A}_{_}ₘᵤₛₜ_{_}_{offset}_{_}₂ from eNB. Next, method 300 moves to Step S302, determining second power allocation information specific to UE2 based on the second power parameter and the second power offset. According to the embodiments of the present disclosure, second power allocation information P_{A}_{_}₂′ specific to UE2 may be determined by computing P_{A}_{_}₂′=P_{A}_{_}₂+P_{A}_{_}ₘᵤₛₜ_{_}_{offset}_{_}₂.

Now, the method 300 ends.

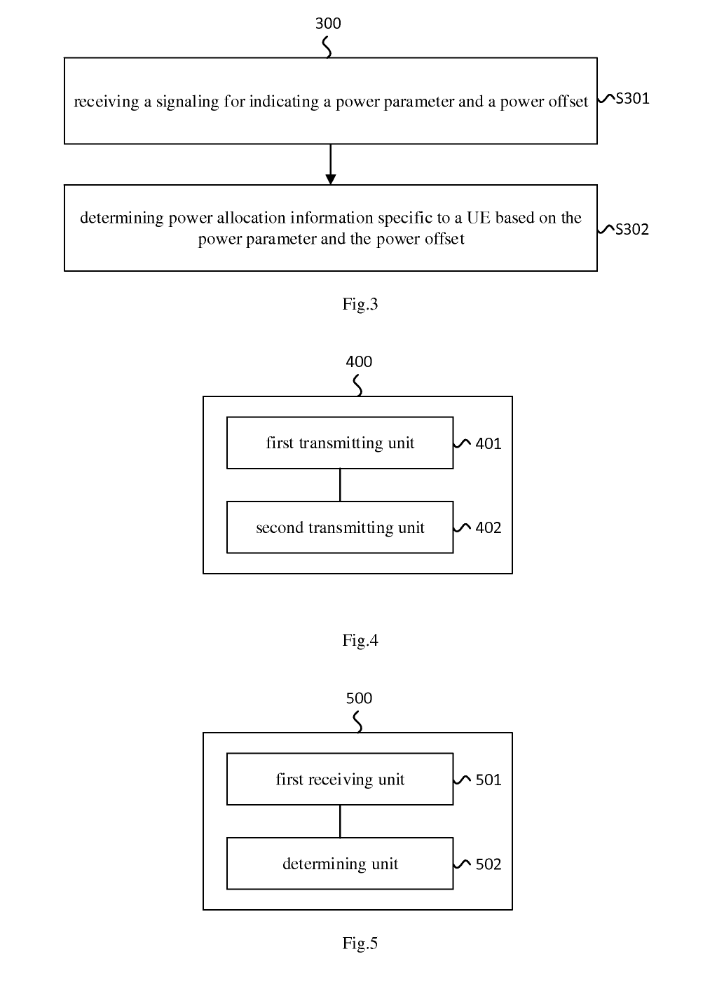

FIG. 4 illustrates a block diagram of an apparatus 400 for indicating power allocation in multiuser superposition transmission according to the embodiments of the present disclosure. As shown in FIG. 4, the apparatus 400 comprises first transmitting unit 401 configured to transmit a signaling for indicating a first power parameter and a first power offset to a first UE so that the first UE determines first power allocation information specific to it based on a first power parameter and a first power offset; and second transmitting unit 402 configured to transmit a signaling for indicating a second power parameter and a second power offset to a second UE paired so that the second UE determines second power allocation information specific to it based on the second power parameter and the second power offset.

According to the embodiments of the present disclosure, UE 1 and UE2 are located in the same cell. For instance, UE1 is located in the relatively more central position than UE2.

According to the embodiments of the present disclosure, the first transmitting unit is configured to transmit a signaling for indicating the second power parameter and the second power offset to the first UE.

According to the embodiments of the present disclosure, the apparatus 400 further comprises third transmitting unit configured to transmit a signaling for indicating Gray mapping operation to the first UE for multiuser superposition transmission based on Gray mapping.

FIG. 5 illustrates a block diagram for an apparatus 500 for indicating power allocation in multiuser superposition transmission according to the embodiments of the present disclosure. As shown in FIG. 5, the apparatus 500 comprises first receiving unit 501 configured to receive a signaling for indicating a power parameter and a power offset; and determining unit 502 configured to determine power allocation information specific to a UE based on the power parameter and the power offset.

According to the embodiments of the present disclosure, if the UE is a first UE, the first receiving unit is configured to: receive a signaling for indicating a first power parameter and a first power offset; and receive a signaling for indicating a second power parameter and a second power offset associated with a second UE; wherein the first UE and the second UE are located in the same cell, for instance, the first UE is located in the relatively more central position than the second UE.

According to the embodiments of the present disclosure, if the UE is the first UE, the determining unit is configured to: determine first power allocation information specific to the first UE based on the first power parameter and the first power offset; and determine second second power allocation information specific to the second UE based on the second power parameter and the second power offset.

According to the embodiments of the present disclosure, if the UE is the first UE, the apparatus 500 further comprises: first decoding unit configured to decode the signal of the second UE based on the second power allocation information; and interference removing unit configured to remove interference caused by the second UE based on the decoded signal of the second UE.

According to the embodiments of the present disclosure, if the UE is the first UE, the apparatus 500 further comprises: second receiving unit configured to receive a signaling for indicating Gray mapping operation; and second decoding unit configured to decode the received signal based on the signaling for indicating Gray mapping operation.

According to the embodiments of the present disclosure, if the UE is a second UE, the first receiving unit is configured to receive a second signaling for indicating a second power parameter and a second power offset; and the determining unit is configured to determine power allocation information specific to the second UE based on the second power parameter and the second power offset.

To sum up, according to the embodiments of the present disclosure, a method and apparatus for indicating power allocation in multiuser superposition transmission are provided so that near victim UE of the paired UEs can decode interference signal from far/interfering UE based on power allocation information and remove interference signal caused by far/interfering UE to improve correctness of decoding its own PDSCH data.

Generally, exemplary embodiments of the present disclosure can be implemented in hardware or dedicated circuit, software, logic or any combination. Some aspects may be implemented in hardware while the other aspects may be implemented in firmware or software implemented by controller, microprocessor or other computing devices. When aspects of the embodiments of the present disclosure are illustrated with figures or described with block diagram, flow diagram or represented with other figures, it should be appreciated that the blocks, apparatuses, systems, techniques or methods described herein may be implemented in hardware, software, firmware, dedicated circuit or logic, universal hardware or controller or other computing devices or their some combinations as non-limiting examples.

Meanwhile, the boxes in the flow diagrams can be considered as method steps, and/or operations generated by operation of computer program codes, and/or considered as a plurality of coupled logic circuit units implementing the functions. For example, embodiments of the present disclosure comprise computer program products which comprise computer programs tangibly implemented on machine-readable mediums and include program codes configured to realize the methods described above.

In the context of the disclosure, machine-readable medium may be any tangible medium comprising or storing programs for instructing implementation system, apparatus or device. The machine readable medium may be machine readable signal medium or machine readable storage medium. The machine readable medium may comprise but is not limited to, electronic, magnetic, optical, electromagnetic, infrared or semiconductor system, apparatus or device, or any proper combination thereof. More detailed example of the machine readable storage medium comprises electrical connection with one or more leads, portable computer disk, hard disk, random access memory (RAM), read only memory (ROM), erasable programmable read only memory (EPROM or flash disk), optical storage device, magnetic storage device, or any proper combination thereof.

The computer program code for implementing the method of the present disclosure may be programmed with one or more programming languages. The computer program code may be provided to the processor of a universal computer, a dedicated computer or other programmable data processing apparatuses so that the computer code, when implemented by computer or other programmable data processing apparatuses, causes the function/operation specified by flow diagram and/or block diagram to be implemented. The program code can be implemented wholly on the computer, partially on the computer, as an independent software package, partially on the computer and partially on the remote computer or wholly on a remote computer or server.

Though the operations are described in a particular order, it should not interpreted that such operations are required to be completed in the particular order or in the successive order shown in the text, or all the operations shown in the figures should be implemented to achieve the expected result. Under some conditions, multitask or parallel processing will be beneficial. Similarly, though some specific implementing details are contained in the above discussion, it should not be interpreted as limiting the scope of the invention or claims but as the description of particular embodiments regarding a particular invention. Some features described in the context of embodiments discussed separately in the specification may also be integrated in a single embodiment, and vice versa, features described in the context of an embodiment may also be implemented in several embodiments or any sub-combination separately.

Various amendments and variations for the exemplary embodiments of the present disclosure will be more apparent for those skilled in the art reading the above description with reference to the drawings. Any or all the amendments still fall under the un-limiting scope of exemplary embodiments of the present disclosure. Moreover, the aforementioned specification and drawings have illuminating benefits. Those skilled in the art in relation to the embodiments of the present disclosure would envisage other embodiments of the present disclosure illustrated herein.

It should be appreciated that embodiments of the present disclosure are not limited to the specific embodiments of the present disclosure and modifications and other embodiments shall all be encompassed in the scope of the appended claims. Though specific terms are employed herein, they should be used employed in universal and descriptive sense, rather than for limiting purpose.

1. A method for indicating power allocation in multiuser superposition transmission, comprising:
transmitting a signaling for indicating a first power parameter and a first power offset to a first user equipment (UE) so that the first UE determines first power allocation information specific to it based on the first power parameter and the first power offset; and
transmitting a signaling for indicating a second power parameter and a second power offset to a second UE paired with the first UE so that the second UE determines second power allocation information specific to it based on the second power parameter and the second power offset.

2. The method according to claim 1, wherein the first UE and the second UE are located in the same cell.

3. The method according to claim 2, wherein transmitting a signaling for indicating the first power parameter and the first power offset to the first UE further comprises:
transmitting a signaling for indicating the second power parameter and the second power offset to the first UE.

4. The method according to claim 2, further comprising:
transmitting a signaling for indicating Gray mapping operation to the first UE for multiuser superposition transmission based on Gray mapping.

5. A method for indicating power allocation in multiuser superposition transmission, comprising:
receiving a signaling for indicating a power parameter and a power offset; and
determining power allocation information specific to a UE based on the power parameter and the power offset.

6. The method according to claim 5, wherein if the UE is a first UE, receiving the signaling indicating the power parameter and the power offset comprises:
receiving a signaling for indicating a first power parameter and a first power offset; and
receiving a signaling for indicating a second power parameter and a second power offset associated with a second UE;
wherein the first UE and the second UE are located in the same cell.

7. The method according to claim 6, wherein determining power allocation information specific to the UE based on the power parameter and the power offset comprises:
determining first power allocation information specific to the first UE based on the first power parameter and the first power offset; and
determining second power allocation information specific to the second UE based on the second power parameter and the second power offset.

8. The method according to claim 7, further comprising:
decoding a signal of the second UE based on the second power allocation information; and
removing interference caused by the second UE based on the decoded signal of the second UE.

9. The method according to claim 5, wherein if the UE is a first UE, the method further comprises:
receiving a signaling for indicating Gray mapping operation; and
decoding the received signal based on the signaling for indicating Gray mapping operation.

10. The method according to claim 5, wherein if the UE is a second UE,
receiving the signaling for indicating the power parameter and the power offset comprises:
receiving a second signaling for indicating a second power parameter and a second power offset; and
determining second power allocation information specific to the UE based on the power parameter and the power offset comprises:
determining power allocation information specific to the second UE based on the second power parameter and the second power offset.

11. An apparatus for indicating power allocation in multiuser superposition transmission, comprising:
first transmitting unit configured to transmit a signaling for indicating a first power parameter and a first power offset to a first UE so that the first UE determines first power allocation information specific to it based on the first power parameter and the first power offset; and
second transmitting unit configured to transmit a signaling for indicating a second power parameter and a second power offset to a second UE paired with the first UE so that the second UE determines second power allocation information specific to it based on the second power parameter and the second power offset.

12. The apparatus according to claim 11, wherein the first UE and the second UE are located in the same cell.

13. The apparatus according to claim 12, wherein the first transmitting unit is further configured to:
transmit a signaling for indicating the second power parameter and the second power offset to the first UE.

14. (canceled)

15. An apparatus for indicating power allocation in multiuser superposition transmission, comprising:
first receiving unit configured to receive a signaling for indicating a power parameter and a power offset; and
determining unit configured to determine power allocation information specific to a UE based on the power parameter and the power offset.

16. The apparatus according to claim 15, wherein if the UE is a first UE, the first receiving unit is configured to:
receive a signaling for indicating a first power parameter and a first power offset; and
receive a signaling for indicating a second power parameter and a second power offset associated with a second UE;
wherein the first UE and the second UE are located in the same cell.

17.-20. (canceled)
